(19) United States
(12) Patent Application Publication
(10) Pub. No.: US 2014/0062192 A1
(43) Pub. Date: Mar. 6, 2014

(54) GRID INTERACTIVE DOUBLE CONVERSION INVERTER

(71) Applicant: Axion Power International, Inc., New Castle, PA (US)

(72) Inventor: Vladimir Vichnyakov, New Castle, PA (US)

(73) Assignee: Axion Power International, Inc., New Castle, PA (US)

(21) Appl. No.: 14/017,667

(22) Filed: Sep. 4, 2013

Related U.S. Application Data
(60) Provisional application No. 61/696,925, filed on Sep. 5, 2012.

(51) Int. Cl. H02J 3/00

(52) U.S. Cl. CPC H02J 3/00
USPC 307/26

(57) ABSTRACT

A system includes an uninterruptible power supply and a grid-tie inverter, connected to batteries via double conversion of high quality DC power sources. A Grid Interactive Double Conversion unit includes DC source with MPPT control and power modulation; a Bi-directional DC battery port; a Bi-direction AC grid port; a Pure Sine wave AC output; a Generator AC input, and DC contacts to prevent the inverter from back feeding generator during a power failure.

This U.S. application claims priority to U.S. Ser. No. 61/696,925 filed on Sep. 5, 2013, the entirety of which is incorporated herein by reference.

### FIELD OF INVENTION

The present invention is directed to the combination of UPS (uninterruptible power supply) and GTI (grid-tie inverter) connected to batteries in such a manner to provide high quality power at all times (even during grid outages) via double conversion of high quality DC power sources. Additionally, this multi-function unit supports the smooth inclusion of intermittent renewable energy sources (e.g., solar, wind) as well as backup power during grid outages (with power quality maintained).

### BACKGROUND OF INVENTION

Many problems can result from poor power quality, especially in today's complex microelectronics environment. Electrical disturbances on mechanical equipment went unnoticeable in the past but can upset today's high-tech equipment. It is normal for electric service voltage to vary within the prescribed limits set by ANSI C84.1-2011. These fluctuations can result from the normal operation of a utility's electric transmission and distribution system, among other reasons. Usually, these voltage changes will not cause problems for your equipment or facilities. However, increase in use of electronic equipment that may be sensitive to these voltage fluctuations, is starting to cause problems.

There are typically nine power quality issues: Power Failure, Power Sag, Power Surge, Under-Voltage, Over-Voltage, Electrical Line Noise, Frequency Variation, Switching Transients and Harmonic Distortion.

Increase in power quality issues has led to the development of surge suppressors, line conditioners and Uninterruptible Power Supplies (UPS).

Double Conversion UPS

Existing UPS solutions provide 3 primary functions for the user:

1. A line-interactive or double-conversion UPS conditions the incoming dirty power from the utility company. The unit filters out the grid irregularities and provides clean uninterruptible power.

2. It provides ride-through power to cover for sags or short-term outages depending on power requirements and battery size.

3. It enables equipment to be power down in a systematic manner.

There are four main types of UPS's available on the market: Standby, Line Interactive, Double Conversion and Double Conversion on Demand. The double conversion units address all nine of the power quality issues listed above.

A double conversion UPS is able to address the above power quality issues because it takes the input AC grid power and converts it to a DC power. The DC bus is connected with a battery bank that is used to filter out the irregularities in the source power. The DC power is the converted to AC through an inverter than is capable of creating a pure sine wave AC power. A typical double conversion UPS configuration for providing back-up power during grid outages is schematically represented below in FIG. 1.

When grid is present, UPS battery bank is maintained at full charge and UPS maintains high power quality via double conversion. When grid is absent, the battery bank discharges to provide UPS back-up power.

Grid Tie Inverter

A grid-tie inverter is a power inverter that converts direct current (DC) electricity into alternating current (AC) with an ability to synchronize to an interface with a utility line. It is used to convert DC power sources, such as solar panels or small wind turbines, into AC power.

Residences and businesses that have a grid-tied electrical system have the opportunity to sell their energy to the utility grid, where net metering is available. In the US, net metering policies vary by jurisdiction. Another policy is a feed-in tariff, where the producer is paid for every kilowatt hour delivered to the grid by a special tariff based on a contract with the distribution company or other power authority.

Grid-tie inverters are designed to quickly disconnect from the grid if the utility grid goes down. This is an NEC requirement that ensures that in the event of a blackout, the grid tie inverter will shut down to prevent the energy it transfers from harming any line workers who are sent to fix the power grid. The disadvantage of this is that the owner of the equipment cannot generate and use the power in the home or business during a power failure. FIG. 2 is a schematic representation of a typical solar grid tied inverter system.

To overcome this short coming, Grid Interactive Inverters were developed.

Grid Interactive Inverter

A grid interactive inverter performs the same basic functions as a grid tied inverter. In addition to these functions, a grid interactive inverter is bidirectional, meaning it can charge batteries from the grid or discharge solar or battery power into the grid.

The system is capable of maintaining the battery in a state of full charge in preparation for use during power outages. When the grid goes down, the grid-interactive inverter seamlessly steps in to disconnect the grid source and invert DC power from both the solar and battery sources into useable AC power to the loads. The system can charge the batteries during the day from the panels or as required from the grid, or both. Additionally, a user can maximize energy savings via peak shaving by taking advantage of using stored energy to offset utility prices when rates are highest and, in turn, only choose to leverage the grid when pricing is most advantageous. FIG. 3 is a schematic representation of a solar grid interactive inverter system.

Output of Grid Interactive System Coupled to Input of Double Conversion UPS

One possible configuration to achieve the objective of a Grid interactive Double Conversion Inverter would be to series connect a Grid Interactive Inverter to a Double Conversion UPS. FIG. 4 is a schematic representation of this arrangement. The following disadvantages of this arrangement are listed below:

Requires two separate battery packs connected to each system. The battery voltage on the Grid Interactive Inverter system would be 48VDC and the Battery voltage on the double conversion UPS would range between 192 and 480 VDC depending on system size.

No common DC bus which means you end up converting DC to AC in the Grid Interactive System and AC to DC back to AC in the UPS double conversion system. This leads to lower overall system efficiencies.

Double Conversion UPS typically have large inrush currents, this requires the Grid Interactive System to be sized about 2-3 times larger in power than the UPS. (10 kW UPS would require a 20-30 kW Grid Tied Inverter). The same holds true for a UPS coupled to a backup generator.

### SUMMARY OF INVENTION

According to one embodiment of the present invention, a system is provided comprising a UPS (uninterruptible power supply) and a GTI (grid-tie inverter), connected to batteries via double conversion of high quality DC power sources.

According to another embodiment of the present invention, a Grid Interactive Double Conversion unit is provided comprising DC source with MPPT control and power modulation; Bi-directional DC battery port; Bi-direction AC grid port; Pure Sine wave AC output; Generator AC input, with DC contacts to prevent inverter from back feeding generator during a power failure.

In the following description, reference is made to the accompanying drawings, which are shown by way of illustration to specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### BRIEF DESCRIPTION OF THE DRAWINGS

FIG. 1 is a schematic representation of a typical double conversion UPS.

FIG. 2 is a schematic representation of a typical solar grid tied inverter system.

FIG. 3 is a schematic representation of a typical solar grid interactive inverter system.

FIG. 4 is a schematic representation of a Grid Interactive System Coupled to a Double Conversion UPS.

FIG. 5 is an electrical schematic of Grid Interactive Double Conversion Inverter

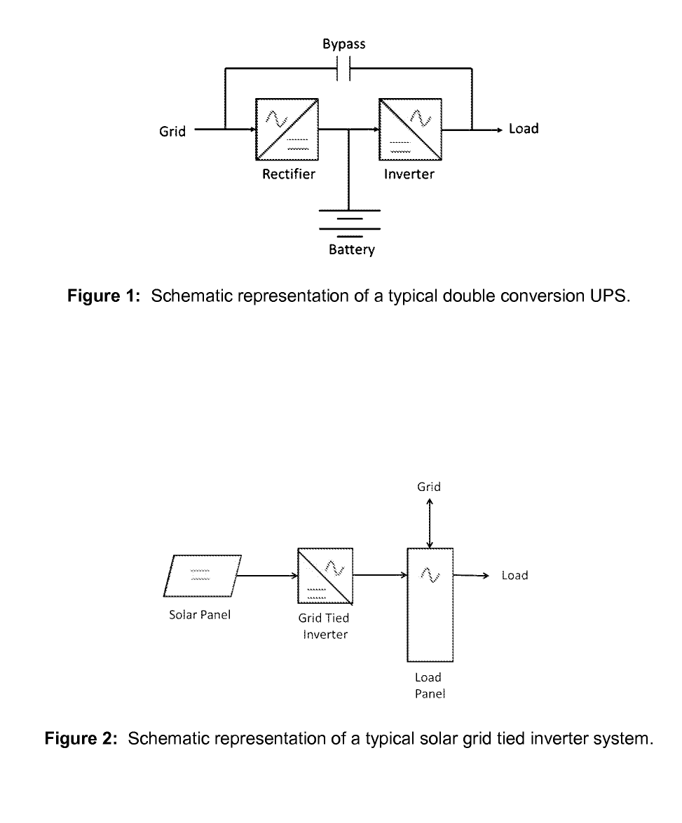

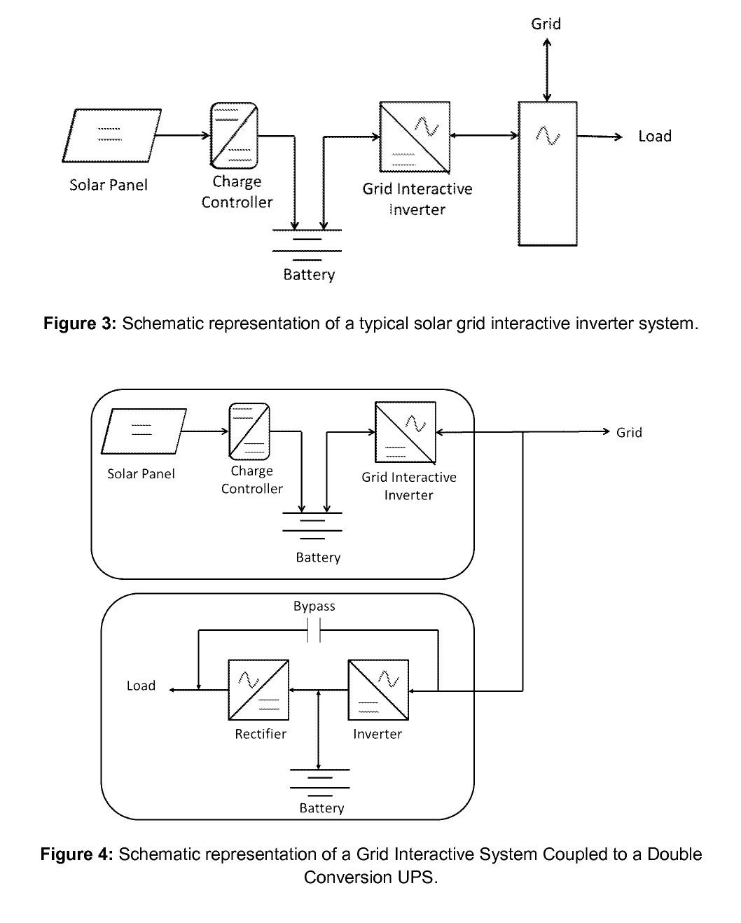

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated. Thus, the invention can include any variety of combinations and/or integrations of the embodiments described herein.

### DETAILED DESCRIPTION OF INVENTION

### Power Grid Interactive Double Conversion Inverter of the Present Invention

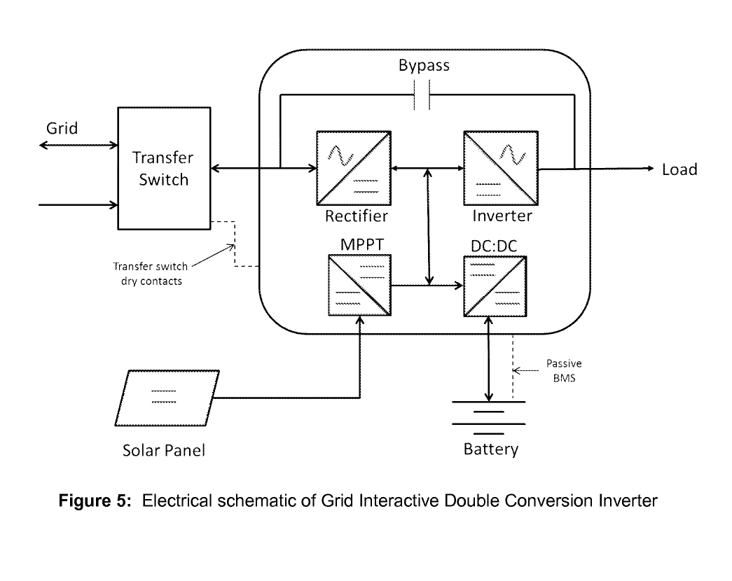

According to an embodiment of the present invention, the Grid Interactive Double Conversion unit schematically represented in FIG. 5 has the following advantages:

1. Dynamic Control of power inputs and outputs

Solar DC source with MPPT (Maximum Power Point Tracking) control and power modulation;

a. Bi-directional DC battery port;

b. Bi-direction AC grid port;

c. Pure Sine wave AC output; and

d. Generator AC input, with DC contacts to prevent inverter from back feeding generator during a power failure.

2. High Voltage Solar Input

a. Most grid interactive Systems that provide battery backup, such as Outback require the solar to be at lower voltage levels. This requires series/parallel stringing with large currents coming off the solar array. This in turn requires larger wire sizing and multi-channel combiner boxes. With a 600 V solar input a larger number of modules can be placed in series and thus use smaller wire due to less current. Due to fewer parallel strings wiring is simpler.

3. High Voltage Battery Bank

a. Allows for a common DC bus between the solar input and battery bank;

b. kWh of system can be extended by paralleling additional battery banks;

c. Battery can be used for storage or smoothing of solar input;

d. Unit is capable of black starting; and

e. Any battery technology can be used.

Battery technology includes, but is not limited to, asymmetric lead-carbon batteries (e.g., batteries with a positive electrode comprising lead and/or lead dioxide and a negative electrode comprising activated carbon, also known commercially as PbC® batteries available from Applicant), Ni-Metal-Hydride (NiMH) batteries, Li-ion batteries, and lead-acid batteries. In a specific embodiment, PbC® may be used for renewable integration.

4. Common DC Bus:

a. Solar DC Power can be used to directly charge batteries, power the load, net meter power to grid or any combination.

b. Battery bank can provide power to load in the case of a power failure. It can assist solar array in meeting output load in the event of a power failure.

c. System can maximize energy savings via peak shaving by taking advantage of using stored energy to offset utility prices when rates are highest and, in turn, only choose to leverage the grid when pricing is most advantageous

5. No external disconnect from Grid

Systems like SMA's Sunny Island require an external disconnect from the grid if using the Sunny Island to excite their line of grid tied inverters. With the totally integrated approach the grid is isolated and the Solar can continue to support the load and charge the batteries with excess power.

Additionally, systems like the SMA Sunny Island need to provide a way to turn down the Solar coming from the grid tied inverters in the event the batteries are charged and the load is not drawing enough power, thus excess capacity has to be dumped. SMA's approach along with micro-inverter manufacturers is to vary the line frequency outside the grid tied inverters operating range and as a result the grid tied inverters turn off. In the integrated approach the solar can be throttled back without subjecting the load to a variance in the line frequency. Also, the excess power can be dumped in smaller increments and not by turning off entire grid tied inverters.

6. Double conversion will provide pure sine wave power with no interruption during switch over from grid to battery.

7. Smart Grid and Demand response ready

a. Unit capable of RS485, RS485 over IP and internet communication.

b. Generator transfer switch could be external as shown in schematic or integrated into the system and provide dry contacts to generator for starting when the grid failure occurs and the battery bank has been depleted.

System Specifications According to One Embodiment of the Present Invention:

| | |
|---|---|
| DC Inputs: | |
| Battery Voltage Range | 160-600 VDC |
| PV MPPT Range | 260-590 VDC |
| PV Array Configuration | Positive or Negative Ground |
| Control Functions | Battery Charge/Discharge/Bulk/Float/PV |
| | MPPT Charge Control |
| AC Grid Input | |
| Specifications: | |
| Voltage | 120/240/VAC +10%/−12% (split-Phase) |
| Power Factor | 0.80 (lag) - 1.0-0.80 (lead) at rated power |
| Line Frequency | 60 HZ (nominal) |
| AC Load Output | |
| Specifications: | |
| Voltage | 120/240 VAC ±1% |
| Frequency Range | 60 Hz |
| Harmonics | <2.0% |
| Voltage Waveform | True Sine |

### American National Standard for Electric Power Systems and Equipment—Voltage Ratings (60 Hz)

### ANSI C84.1-2011

Although specific embodiments of the invention have been described herein, it is understood by those skilled in the art that many other modifications and embodiments of the invention will come to mind to which the invention pertains, having benefit of the teaching presented in the foregoing description and associated drawings.

It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

What is claimed is:

1. A system comprising a UPS (uninterruptible power supply) and a GTI (grid-tie inverter), connected to batteries via double conversion of high quality DC power sources.

2. A system according to claim 1, further comprising intermittent renewable energy sources and as well as backup power during grid outages.

3. A system according to claim 2, wherein said intermittent renewable energy sources comprises solar and/or wind.

4. A Grid Interactive Double Conversion unit, comprising:
DC source with MPPT control and power modulation;
Bi-directional DC battery port;
Bi-direction AC grid port;
Pure Sine wave AC output;
Generator AC input, with DC contacts to prevent inverter from back feeding generator during a power failure.

5. A unit according to claim 4, comprising a Battery Bank that allows for a common DC bus between a solar input and battery bank.

6. A unit according to claim 5, wherein the Batter Bank comprises at least one of asymmetric lead-carbon batteries, Ni-Metal-Hydride (NiMH) batteries, Li-ion batteries, and lead-acid batteries.

7. The system shown and described in FIG. 5.

8. A residential or business energy storage unit comprising the system of claim 7.
